(19) United States
(12) Patent Application Publication
(10) Pub. No.: US 2019/0182284 A1
(43) Pub. Date: Jun. 13, 2019

(54) BLOCKCHAIN-BASED SECURITY THREAT DETECTION METHOD AND SYSTEM

(71) Applicant: Alcatel Lucent, Nozay (FR)

(72) Inventors: Matteo Signorini, Nozay (FR); Roberto Di Pietro, Nozay (FR); Wael Kanoun, Nozay (FR)

(73) Assignee: Alcatel Lucent, Nozay (FR)

(21) Appl. No.: 16/325,564

(22) PCT Filed: Jul. 13, 2017
(86) PCT No.: PCT/EP2017/067762

§ 371 Date: Feb. 14, 2019

(30) Foreign Application Priority Data
Aug. 16, 2016 (EP) 16306061.9

(51) Int. Cl. H04L 29/06; G06F 21/55

(52) U.S. Cl. CPC H04L 63/1425; G06F 21/552

(57) ABSTRACT

A method and system of detecting a security threat within a network of connected devices that share a ledger of transactions between them under the form of exchanged blockchain messages (50). Enhanced blockchain messages are built by adding all forked chains (51) to the blockchain messages (50). Forked chains in such enhanced blockchains are then inspected to detect any anomaly. When an anomaly is detected in a forked chain, all transactions of the ledger in the forked chain (51) and the blockchain message (50) leading up to the network attack entry point are reviewed to identify the source of the security threat.

### FIELD OF THE INVENTION

The invention relates to the technical field of security within a network of connected devices implementing blockchain technology.

### BACKGROUND

The Internet of Things has brought on a considerable number and a wide range of connected and smart devices on the market, which are able to communicate/cooperate with each other and to be remotely accessed via Internet. This creates specific threats to the security and privacy of both the involved connected and smart devices, and the other devices connected to them. Indeed weak security systems embedded in connected and smart devices may be exploited to get into the network and, from there, to get access to more powerful devices such as servers, laptops, etc.

To address these security issues, current systems are based on log analysis and data correlations and are aimed at building attack models and risk mitigation strategies on top of them. Malware however is getting more and more sophisticated, capable of bypassing monitoring systems, by removing its own footprint, and by moving quickly from one victim (ie: connected device) to the next in order to make it hard for the monitoring system to find it and track it.

More recently, blockchain technology was devised and published (originally in the context of Bitcoin) allowing to securely share or process data between multiple parties over a network of non-trusted peers.

### SUMMARY

The invention provides for blockchain-based security threat detection method and system.

A method is provided of detecting a security threat within a network of connected devices that share a ledger of transactions between them under the form of exchanged blockchain transactions, with the steps of (a) building enhanced blockchain structure by keeping all the information of the forked chains; (b) inspecting forked chains in the enhanced blockchain structure; (c) detecting an anomaly based on patterns in the forked chains; (d) identifying the security threat by reviewing all transactions of the ledger in the forked chain and the blockchain transactions leading up to the network attack entry point; and (e) exchanging enhanced blockchain transactions between connected devices.

More particularly, the invention provides for a method of detecting a security threat within a network of connected devices that share a ledger of transactions between them under the form of exchanged blockchain messages, comprising the steps of:
building an enhanced blockchain by adding forked chains discarded at a device, to a standard blockchain;
inspecting added forked chains in the enhanced blockchain;
detecting an anomaly based on patterns in the added forked chains in the enhanced blockchain;
identifying the security threat by reviewing all transactions of the ledger in the forked chain in which an anomaly has been detected, and in the standard blockchain leading up to the network attack entry point; and
including the enhanced blockchain in the exchanged messages.

In one embodiment of the method, simultaneous processing of the standard blockchain, and building the enhanced blockchain, take place at a device.

In another embodiment of the method, the step of detecting an anomaly further comprises the step of detecting behaviors in the added forked chains that were not accepted by the whole network.

A device is also provided, to be connected to such a network of connected devices that share a ledger of transactions between them under the form of exchanged blockchain messages, which comprises (a) a miner being configured to analyze and update blockchain transactions in a blockchain database; (b) a fork broadcast being configured to extract forked chains from the blockchain transactions and to send them to other devices; (c) a chain manager being configured to build an enhanced blockchain by adding all forked chains to the original blockchain; and (d) an anomaly detection system being configured to inspect the enhanced blockchain and detect security threats.

More particularly, the invention provides for a device to be connected to such a network, with the device comprising a miner being configured to analyze and update received blockchain messages in a blockchain database, and further comprising:
a fork broadcast being configured to extract forked chains from the blockchain messages;
a chain manager being configured to add all forked chains to the blockchain messages in order to build an enhanced blockchain to be included in messages sent to other devices in the network; and
an anomaly detection system being configured to inspect the enhanced blockchain and detect security threats.

In one embodiment the device further comprises:
a transaction filter being configured to intercept blockchain messages and to forward them to both the miner and the chain manager, wherein blockchain messages are processed in parallel by the miner and the chain manager.

In yet another embodiment, the transaction filter in the device is further configured to collect metadata from the blockchain messages, and to discard duplicated blockchain messages received from the network.

In yet another embodiment, the device further comprises:
a pattern inspector configured to detect behaviors in the forked chains that were not accepted by the whole network.

In yet another embodiment, the device further comprises:
a threat detector configured to, once a behavior has been detected by the pattern inspector, inspect the sections of the standard blockchain linked to the forked chains containing the detected behavior, in order to recover the source of a security threat.

In yet another embodiment, the device further comprises a threat database configured to collect information about the security threat.

### BRIEF DESCRIPTION OF THE DRAWINGS

These and other aspects of the invention will be apparent from and elucidated with reference to the embodiments described hereinafter, by way of example, with reference to the drawings.

FIG. 1 is a representation of a network with connected devices implementing the blockchain technology (prior art).

FIG. 2 is a functional representation of a connected device that performs mining in the network (prior art).

FIG. 3 is a representation of a network with the blockchain-based security threat detection method and system according to the invention.

FIG. 4 is a functional representation of a connected device that implements the blockchain-based security threat detection method and system according to the invention.

FIG. 5 illustrates the enhanced blockchain built by the chain manager according to the invention.

FIG. 6 illustrates the inspection performed on the enhanced blockchain by the threat detector.

### DETAILED DESCRIPTION OF THE EMBODIMENTS

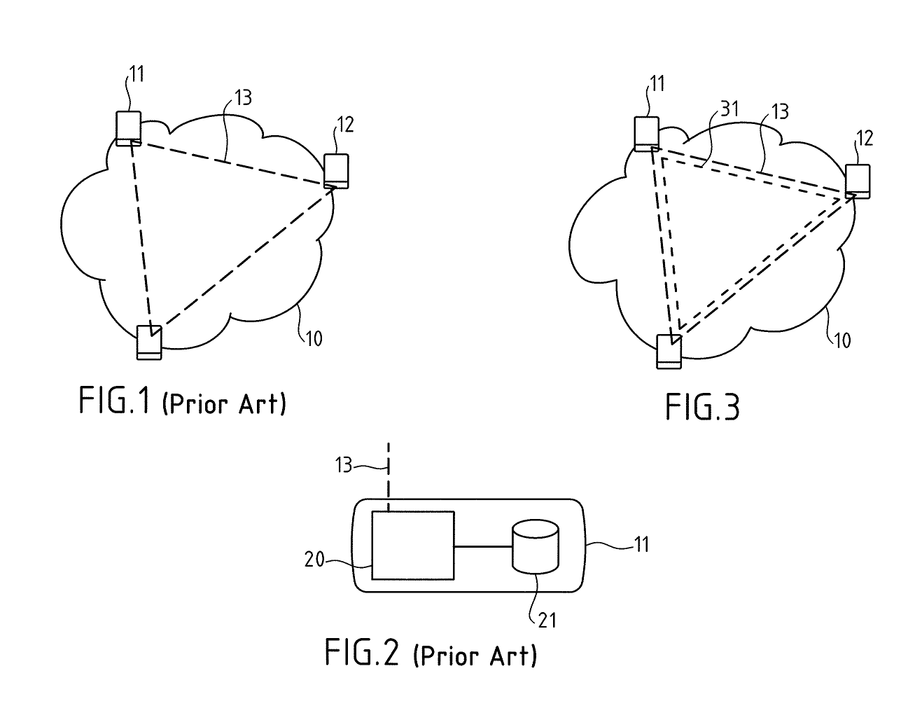

FIG. 1 is a representation of a network (10) with connected devices (11, 12) implementing the blockchain technology. Network 10 may be Wifi, 3G, LTE, Bluetooth, RFID/NFC, wired connections, or any type of network that supports protocols for exchanges of messages between connected devices over connections (13). The messages being exchanged can belong to one or multiple blockchain-based applications on different levels such as HTTP/FTP based applications (to keep track of network traffic), SSH/Telnet/RDP/VNC/VPN based applications (to keep track of remote accesses), RFID/NFC based applications (to keep track of physical interactions), etc.

A connected device (11) that acts as a validating peer within the network, including maintaining the ledger shared between connected devices, contains a miner (20) as illustrated on FIG. 2. Messages (13) received by the miner contain standard blockchain transactions which are collected to build the next block within the chain. Once a new block has been built by the miner, or by another device within the network, it is added to the blockchain, written in a blockchain database (21) and sent in broadcast to the other devices. Once a device receives one or multiple blocks which have been built by other devices, it compares the new blocks with the one locally stored. If they do not match and the number of blocks received is larger than the number of locally stored blocks, the local chain is labeled as a fork. Once a fork is detected, the miner discards it and overwrites a portion/all of the blockchain with those new received blocks that were previously verified and accepted by the network and that form a longer chain. Forks are typically discarded as the blockchain is based on a concurrent mining process (i.e. each connected device locally contributes in the update of the chain), where temporary forks (i.e. parallel branches from the main chain) may be created and distributed in the network. These parallel branches, may lead to conflicting transactions between nodes/connected devices, which in the context of crypto-currencies for example, such as in the Bitcoin network, is particularly problematic.

In contrast, and according to the invention, on FIG. 3 additional messages over connections (31) exchanged between connected devices make it possible to share not only the standard blockchain, but also all its forks, thus creating a bigger and enhanced blockchain that is used for security threat detection. A novel decentralized anomaly detection system based on the blockchain technology is thus provided.

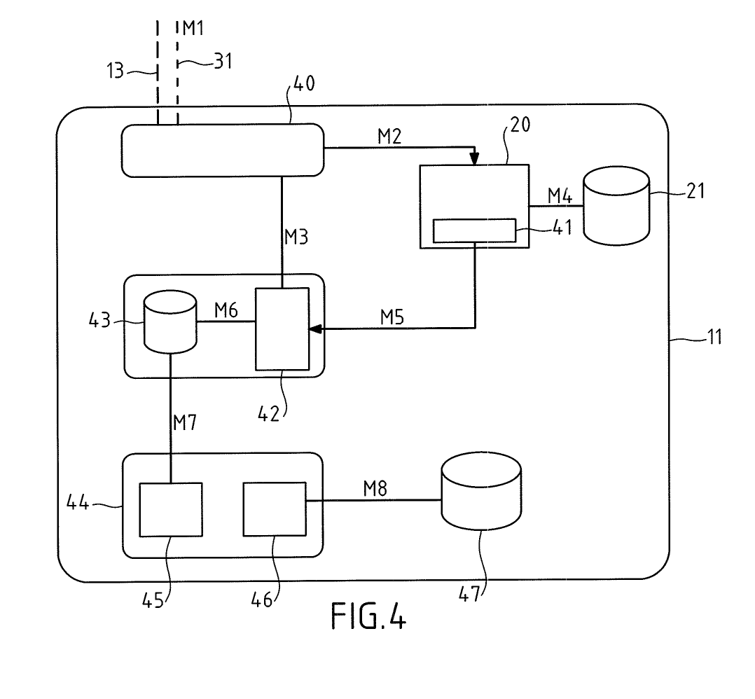

A connected device (11) according to the invention is illustrated on FIG. 4. The device contains the miner (20) and the blockchain database (21). In addition, it contains:
a transaction filter (40) that intercepts blockchain messages (M1) and forwards them to both the miner (with M2 messages), and a chain manager (42) with M3 messages. This parallel processing allows the un-interrupted (ie: not modified or slowed down) handling of standard blockchain protocol by the miner and the blockchain database, through M4 message exchange. The transaction filter collects M1 metadata such as the message sender, the recipient, the timestamp, etc. but also discards duplicated messages as the blockchain technology is based on a broadcast model.
a fork broadcast (41), added to the miner, extracts any forked chain (M5) before it is discarded and overwritten by the miner.
a chain manager (42) receives M3 messages from the transaction filter, and M5 messages from the fork broadcast, and computes from them an enhanced blockchain composed of the standard blockchain, and of taken into account forked chains. As M3 and M5 do not describe the whole chain but rather updates on top of it, the chain manager retrieves through M6 the blockchain built so far from a chain database (43), and then adds to that blockchain all the information obtained with M3 and/or M5. Once the enhanced blockchain has been computed, it is sent back through M6 to the chain database to keep the updated version of such enhanced blockchain. M3 and M5 do not necessarily reach the chain manager at the same time; the chain manager can thus receive either M3 messages (each time a standard blockchain message has been received) or M5 messages (each time M2 forces the miner to discard previous forks).
an anomaly detection system (44) loads, with M7, the up to date version of the enhanced blockchain, containing the history of the network, from the chain database. The anomaly detection system is composed of two subsystems:
   a pattern inspector (45): it detects and keeps track of unusual/unexpected behaviors which are found only in the forked chains (i.e. not accepted by the whole network) in order to detect suspicious patterns, such as a malicious attempt at hacking a SSH authentication, or a denial of service attack targeting a specific machine;
   a threat detector (46): once a suspected behavior/pattern has been detected by the pattern inspector, the threat detector further inspects the forked chain in which the attack has been found and the portion of the standard blockchain linked to it in order to recover the source of such security threat/issue. Starting from the anomalies found by the pattern inspector, it exploits all the transactions downloaded from the forked chain and the blockchain to roll back all the operations done by a victim until a possible root of attack is found. Then, all the information on the attacks (type of activity/protocols, time, responsible connected device, etc.) are collected within a threat database (47) through M8.

FIG. 5 illustrates the enhanced blockchain built by the chain manager 42: it is composed of the standard blockchain (50) headed by a block head (BH), and other forked chains (51), each one headed by its own fork head block (FH). This enhanced blockchain is stored in chain database 43, and passed on to pattern inspector 45.

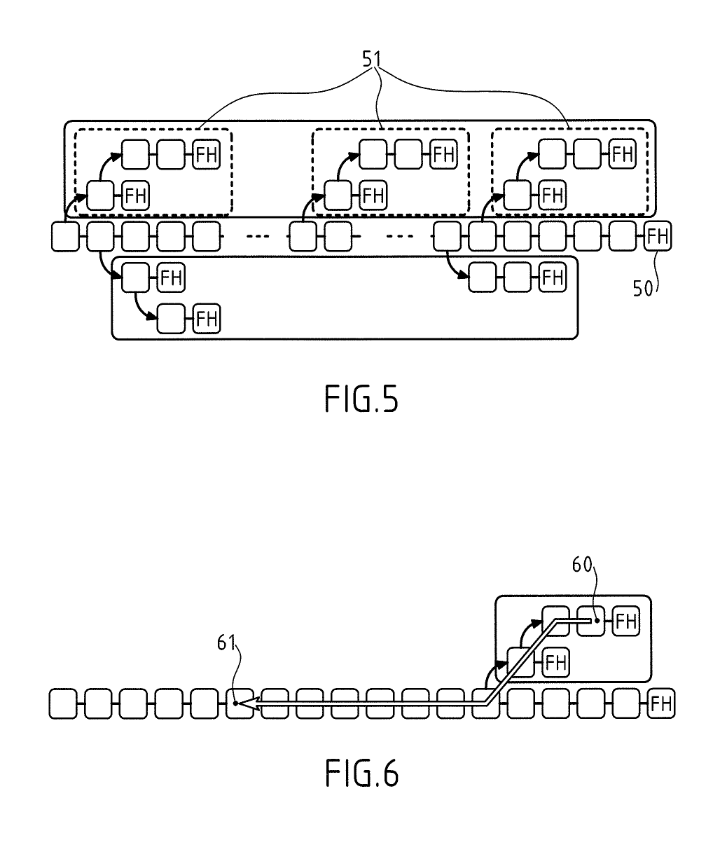

FIG. 6 illustrates the inspection of enhanced blockchains performed by the threat detector. Once an anomaly (60) has been detected in a forked chain by the pattern inspector, the threat detector reviews all the transactions of the ledger in the forked chain and the blockchain message leading up to a network attack entry point (61).

The invention thus leverages unexpected behaviors within forked chains, as they represent different visions of the network's activity and might then describe malicious/strange behaviors or attacks which are not yet known/distributed on a global scale (e.g. a man in the middle attack where HTTP requests are eavesdropped and redirected to a recipient other than the intended one). As such, by collecting not only the main blockchain but also all the local and concurrent forked chains, the invention makes it is possible to derive a global network history which takes into account both global and local unexpected changes. These differences are then analyzed by the anomaly detection system which can detect footprints that the attacker or malicious software tried to remove or even malicious repetitive patterns that might represent the presence of an infected device within the network.

The security the invention introduces cannot be circumvented since, by exploiting the blockchain technology and its forked chains, it is not possible to alter all the replicas of the blockchain collected within each device in the network. As such, any trial aimed at changing or removing malicious activities or at creating fake activities will be recorded within the blockchain and, by linking the forked chain to the standard chain, it will be always possible to go back in time and to find the source of the problem or the attack entry point.

Elements such as the miner, the transaction filter, the fork broadcast, the chain manager, the anomaly detection system, the pattern inspector, or the threat detector, could each be e.g. hardware means like e.g. an ASIC, or a combination of hardware and software means, e.g. an ASIC and an FPGA, or at least one microprocessor and at least one memory with software modules located therein.

The invention is not limited to the described embodiments. The appended claims are to be construed as embodying all modifications and alternative constructions that may occur to one skilled in the art, and which fairly fall within the basic teaching as set forth herein.

The use of the verb “to comprise”, “to include” or “to contain” and their conjugations does not exclude the presence of elements or steps other than those stated in a claim. Furthermore, the use of the article “a” or “an” preceding an element or step does not exclude the presence of a plurality of such elements or steps.

In the claims, any reference signs placed between parentheses shall not be construed as limiting the scope of the claims.

1. A method of detecting a security threat within a network of connected devices that share a ledger of transactions between them under the form of exchanged blockchain messages, comprising:
building an enhanced blockchain by adding forked chains discarded at a device, to a standard blockchain;
inspecting added forked chains in the enhanced blockchain;
detecting an anomaly (60) based on patterns in the added forked chains in the enhanced blockchain;
identifying the security threat by reviewing all transactions of the ledger in the forked chain in which an anomaly has been detected, and in the standard blockchain leading up to the network attack entry point; and
including the enhanced blockchain in the exchanged messages.

2. The method of claim 1 further comprising at a device simultaneously processing the standard blockchain, and building the enhanced blockchain.

3. The method of claim 1 wherein the detecting an anomaly further comprises detecting behaviors in the added forked chains that were not accepted by the whole network.

4. A computer program comprising executable code that causes a computer to perform the method in accordance with claim 1 when executed.

5. A device to be connected to a network where connected devices share a ledger of transactions between them under the form of exchanged blockchain messages, such device comprising a miner being configured to analyze and update received blockchain messages in a blockchain database, and further comprising:
a fork broadcast being configured to extract forked chains from the blockchain messages;
a chain manager being configured to add all forked chains to the blockchain messages in order to build an enhanced blockchain to be included in messages sent to other devices in the network; and
an anomaly detection system being configured to inspect the enhanced blockchain (M7) and detect security threats.

6. The device of claim 5, further comprising:
a transaction filter being configured to intercept blockchain messages and to forward them to both the miner and the chain manager, wherein blockchain messages are processed in parallel by the miner and the chain manager.

7. The device of claim 6, wherein the transaction filter is further configured to collect metadata from the blockchain messages, and to discard duplicated blockchain messages received from the network.

8. The device of claim 5, further comprising:
a pattern inspector configured to detect behaviors in the forked chains that were not accepted by the whole network.

9. The device of claim 8, further comprising:
a threat detector configured to, once a behavior has been detected by the pattern inspector, inspect the sections of the standard blockchain linked to the forked chains containing the detected behavior, in order to recover the source of a security threat.

10. The device of claim 9, further comprising:
a threat database configured to collect information about the security threat.
